(19) United States
(12) Patent Application Publication
(10) Pub. No.: US 2009/0273930 A1
(43) Pub. Date: Nov. 5, 2009

(54) Light-Emitting Diode Module, Method for Producing a Light-Emitting Diode Module and Optical Projection Apparatus

(76) Inventor: Robert Kraus, Regensburg (DE)

Correspondence Address: OSRAM SYLVANIA INC, 100 ENDICOTT STREET, DANVERS, MA, 01923, US

(21) Appl. No.: 12/086,077

(22) PCT Filed: Nov. 7, 2006
(86) PCT No.: PCT/DE2006/001949

§ 371 Date: Jun. 5, 2008

(30) Foreign Application Priority Data
Jun. 14, 2007 (DE) 10 2005 058 884.0

(51) Int. Cl. H05B 37/02; F21V 13/00; H01J 9/42

(52) U.S. Cl. 362/257; 315/297; 315/152; 445/3

(57) ABSTRACT

The invention specifies a light-emitting diode module (20) having at least two light-emitting diode chips (1), a memory unit (2), in which values for the brightness and the color locus of each light-emitting diode chip (1) are stored, and a control unit (3), which is suitable for controlling an operating current through each light-emitting diode chip (1) as a function of the stored values. Such a light-emitting diode module (20) makes particularly precise and reproducible white point representation possible. Furthermore, the invention specifies a method for producing a light-emitting diode module (20) and an optical projection apparatus having such a light-emitting diode module (20).

Light-emitting diode module, method for producing a light-emitting diode module and optical projection apparatus

A light-emitting diode module is specified. Moreover, an optical projection apparatus comprising such a light-emitting diode module is specified. Furthermore, a method for producing a light-emitting diode module is specified.

One object to be achieved consists in specifying a light-emitting diode module whose emitted light has a reproducible color locus which can be set particularly exactly.

In accordance with at least one embodiment of the light-emitting diode module, the light-emitting diode module comprises at least two light-emitting diode chips. The light-emitting diode chips of the light-emitting diode module are arranged for example in one or more light-emitting diode arrays. The light-emitting diode chips can be individually drivable. Each light-emitting diode chip can then be energized by itself, independently of the other light-emitting diode chips of the module. However, it is also possible for the light-emitting diode chips to be arranged in groups of two or more light-emitting diode chips which, by way of example, are connected in series with one another and are thus exclusively jointly drivable.

In accordance with at least one embodiment of the light-emitting diode module, the light-emitting diode module comprises a memory unit. The memory unit is preferably an electronic memory unit suitable for storing values saved in it over periods of time which correspond at least to the average lifetime of the light-emitting diode chips of the module. Values for the brightness and the color locus of the at least two light-emitting diode chips of the light-emitting diode module are stored in the memory unit. Preferably, values for the brightness and the color locus of each light-emitting diode chip of the light-emitting diode module are stored. The values are preferably initial values which are determined prior to the actual start-up of the light-emitting diode module at its intended location by means of a measuring apparatus arranged externally with respect to the light-emitting diode module—that is to say located outside the light-emitting diode module.

That is to say that prior to the start-up of the light-emitting diode module, the light-emitting diode chips are preferably operated at a reference current intensity. Values for the brightness and the color locus of each light-emitting diode chip are determined in this case. Said values are saved for permanent or long-lasting storage in the memory unit of the light-emitting diode module. In this case, the storage time preferably amounts at least to the average lifetime of the light-emitting diode chips of the module.

In accordance with at least one embodiment of the light-emitting diode module, the light-emitting diode module comprises a control unit. The control unit is suitable for controlling an operating current through each light-emitting diode chip in a manner dependent on the values saved in the memory unit. That is to say that depending on the value for the brightness and the color locus for a light-emitting diode chip of the light-emitting diode module, the control unit is suitable for impressing an operating current into the light-emitting diode chip. Furthermore, the control unit is preferably suitable for controlling the current through a specific light-emitting diode chip in a manner dependent on the values stored for this light-emitting diode chip and on the values of all the other light-emitting diode chips of the module. The light-emitting diode module makes use of the following insight: light-emitting diode chips of the same type have fluctuations in brightness and color locus due to production. By way of example, two structurally identical light-emitting diode modules having light-emitting diode chips which are suitable for emitting light of the colors red, green and blue therefore have a different white point when the light-emitting diode chips are operated simultaneously. The white point of two structurally identical modules can differ greatly from one another in this case. Using the control unit of the light-emitting diode module it is made possible to control the current through the individual light-emitting diode chips of the module in a manner dependent on the stored values for brightness and color locus of the light-emitting diode chips in such a way that an exact, reproducible white point representation results. If, by way of example, a light-emitting diode chip with relatively low brightness is situated on the light-emitting diode module, this light-emitting diode chip can be energized to a greater extent than other light-emitting diode chips of the module. If the color locus of a first light-emitting diode chip is shifted toward the color locus of a second light-emitting diode chip, then the current intensity through the second light-emitting diode chip can be reduced with the aid of the control unit.

Thus, in principle, the fluctuations in the white point representation between two structurally identical light-emitting diode modules are determined only by the measurement tolerance during the initial measurement of the light-emitting diode chips.

In accordance with at least one embodiment of the light-emitting diode module, the control unit is suitable for regulating the brightness of each light-emitting diode chip in a manner dependent on at least one measured value, which is in turn dependent on the operating state of the light-emitting diode chipor of other light-emitting diode chips of the module. That is to say that a measured value is determined during operation of the light-emitting diode chips by means of a measuring apparatus. The measured value is transferred to the control unit. The control unit is suitable for regulating the brightness of the light-emitting diode chip depending on the measured value and depending on the values for the brightness and the color locus saved in the memory unit. In this case, the brightness of the light-emitting diode chip can be regulated by control of the operating current impressed into the light-emitting diode chip. Operating state of a light-emitting diode chip is understood to mean for example the temperature or the brightness of the light emitted by the light-emitting diode chip.

In accordance with at least one embodiment of the light-emitting diode module, the control unit is suitable for controlling the operating current intensity of a light-emitting diode chip. That is to say that depending for example on the value saved in the memory unit and, if appropriate, on the measured value dependent on the operating state of the light-emitting diode chip, the control unit is suitable for controlling the intensity of the current impressed into a light-emitting diode chip.

In accordance with at least one embodiment of the light-emitting diode module, the control unit comprises a pulse width modulation circuit. The brightness of a light-emitting diode chip can then be regulated by the setting of the duty ratio, that is to say by the setting of the dead time with constant frequency for the operating current.

The pulse width modulation circuit generates current of a specific intensity I₁ for a specific time interval T₁, for example. For a further specific time interval—the dead time—T₂, no current flows through the light-emitting diode chip (I₂=0). By way of example, the pulse width modulation generates an electrical square-wave signal for this purpose. The higher the duty ratio T₁/(T₁+T₂), the longer current flows through the light-emitting diode chip in the time interval T₁+T₂ and the brighter the appearance of the emitted light to the observer.

The frequency of the pulse width modulation circuit 1/(T₁+T₂) is preferably at least 100 Hz, such that the light-emitting diode chips appear to be continuously luminous to the human observer on account of the inertia of the optical signal processing in humans.

In accordance with at least one embodiment of the light-emitting diode module, the light-emitting diode module comprises a brightness sensor suitable for transferring to the control device a measured value dependent on the brightness of at least one light-emitting diode chip. The control device is then suitable for regulating the operating current through the light-emitting diode chip depending on the measured value. By way of example, it is possible to determine the brightness of a reference light-emitting diode chip of the module. From the value determined, it is then possible to calculate a change in operating current for all the light-emitting diode chips—if appropriate by comparison with the reference value saved in the memory unit. In this way it is possible, for example, to compensate for a change in brightness in comparison with the stored reference value which is attributable for example to ageing of at least one of the light-emitting diode chips.

Furthermore, it is possible for the brightness sensor to be suitable for determining the brightness of the light generated by a group of light-emitting diode chips—for example by detection of stray radiation. For this purpose the light-emitting diode chips can be grouped for example according to the colors for which they emit electromagnetic radiation. Preferably, the module then comprises precisely one brightness sensor for each color.

Furthermore, it is possible for there to be precisely one brightness sensor in the module for each light-emitting diode chip of the light-emitting diode module. This permits particularly accurate monitoring of the brightness of the individual light-emitting diode chips.

In accordance with at least one embodiment of the light-emitting diode module, the module comprises a temperature sensor suitable for transferring to the control unit a measured value dependent on the operating temperature of at least one light-emitting diode chip.

In this case, it is possible for the temperature sensor to be suitable for determining an average operating temperature of all the light-emitting diode chips of the module. Furthermore, it is possible for the temperature sensor to be suitable for determining the operating temperature of a group of light-emitting diode chips. In this case, the light-emitting diode chips can be grouped for example according to the colors for which they emit electromagnetic radiation. Preferably, the module then comprises precisely one temperature sensor for each color group.

Finally, it is also possible for there to be precisely one temperature sensor for determining the operating temperature of the light-emitting diode chip in the module for each light-emitting diode chip of the module. This enables particularly accurate temperature-dependent control of the operating current. The temperature-dependent control of the operating current of the light-emitting diode chips of the light-emitting diode module makes it possible to prevent impairment of the function or even failure of the light-emitting diode chips on account of thermal overloading. By way of example, the temperature detected by the temperature sensor can be evaluated by the control device and the operating current through the light-emitting diode chips can be correspondingly reduced as soon as the temperature detected by the temperature sensor reaches and/or exceeds a critical value. In this way, the light-emitting diode chips can advantageously be operated over long operating times in the limit range of their thermal loading capacity.

In accordance with at least one embodiment of the light-emitting diode module, all the components of the light-emitting diode module are arranged on a common module carrier. The carrier can be a printed circuit board, for example, on which conductor tracks are provided for electrically connecting the components. The carrier preferably contains a material having particularly good thermal conductivity, such as a metal and/or a ceramic material. Preferably the light-emitting diodes, the memory unit, the control unit and, if appropriate, temperature and brightness sensor(s) are arranged on the carrier. Furthermore, further components such as varistor(s)—for protecting the components against electrostatic discharges—or electronic component(s) for transforming a supply voltage—for example an inductor coil or one or a multiplicity of capacitors—can be applied on the module carrier. A method for producing a light-emitting diode module as described in connection with at least one of the above embodiments is furthermore specified.

In accordance with at least one embodiment of the production method, firstly a module carrier is equipped with at least two light-emitting diode chips. The light-emitting diode chips on the module carrier are subsequently operated at a reference current intensity, such that they emit electromagnetic radiation. In this case, for example the brightness and the color locus of each light-emitting diode chip are measured by means of a measuring device arranged externally with respect to the light-emitting diode module.

In a final method step, the measured values or values which correspond to the measured values or are derived from the latter are stored in the memory unit arranged on the module carrier.

In this case, the method makes use of the idea that by storing the initial values for brightness and color locus of each light-emitting diode chip directly on the module, it is possible to produce a light-emitting diode module in which a particularly exact white point representation is made possible during operating. The light emitted by the light-emitting diode module thus has a reproducible color locus which can be set particularly exactly.

Moreover, an optical projection apparatus comprising at least one light-emitting diode module as described in connection with one of the abovementioned exemplary embodiments is specified. In accordance with at least one embodiment, the optical projection apparatus comprises at least one light-emitting diode module. Furthermore, the optical projection apparatus comprises an imaging element—for example an array of micromirrors (DMD—digital mirror device) or one or more LCD (liquid crystal displays) panels. Furthermore, the optical projection apparatus comprises a projection optical unit, such as a projection lens for example. In this case, the use of a light-emitting diode module as described above enables an optical projection apparatus having a particularly exact and reproducible white point representation.

The light-emitting diode module described here is explained in more detail below on the basis of exemplary embodiments and the associated figures. In the exemplary embodiments and figures, identical or identically acting component parts are in each case provided with the same reference symbols. The elements illustrated should not be regarded as true to scale, rather individual elements may be illustrated with an exaggerated size in order to afford a better understanding.

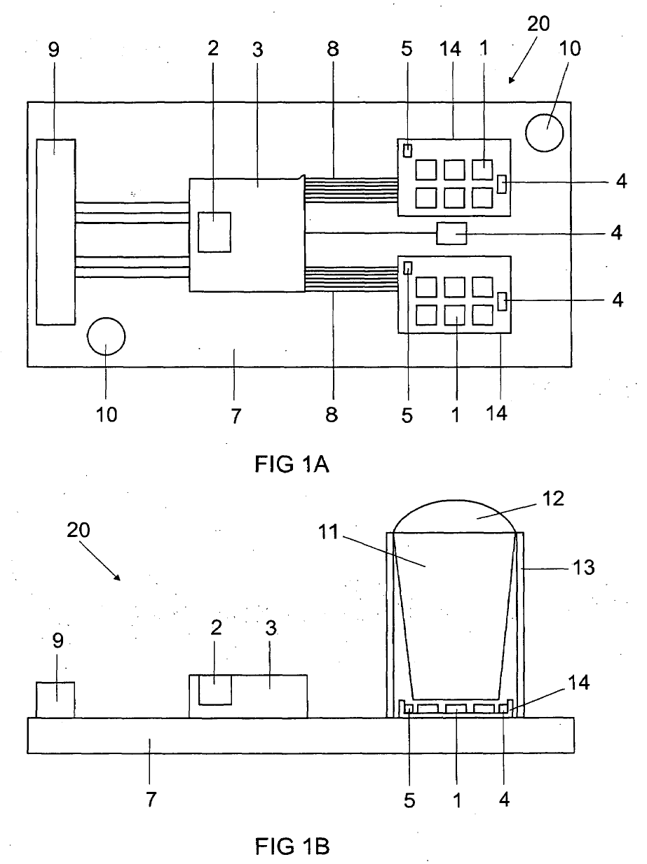

FIG. 1A shows a schematic plan view of a light-emitting diode module in accordance with one exemplary embodiment.

FIG. 1B shows a schematic sectional view of the light-emitting diode module in accordance with the exemplary embodiment.

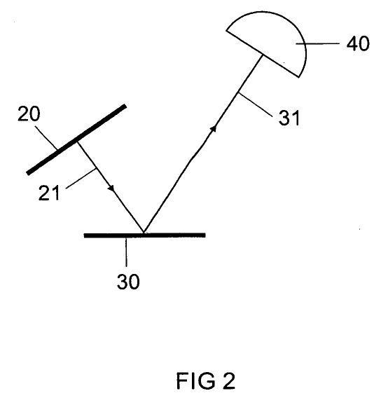

FIG. 2 shows a schematic sectional illustration of the optical projection apparatus in accordance with one exemplary embodiment.

FIG. 1A shows a schematic plan view of a light-emitting diode module in accordance with one exemplary embodiment. FIG. 1B shows the associated schematic sectional illustration. The light-emitting diode module 20 has a module carrier 7. The module carrier 7 is a printed circuit board, which can be embodied for example as a metal-core circuit board. The module carrier preferably contains a metal having good conductivity, such as copper or aluminum, and/or a ceramic having good thermal conductivity, such as, for example, an aluminum nitride, for instance AlN.

Conductor tracks 8 are provided on the module carrier 7, said conductor tracks electrically connecting components of the light-emitting diode module 20 to one another. The module carrier 7 can furthermore have cutouts 10 provided by holes, for example. At the cutouts 10, the light-emitting diode module 20 can be fixed at its intended location for example by fitting pins and/or screws. The light-emitting diode module 20 furthermore has a connector 9, by means of which electrical contact can be made with the light-emitting diode module 20 externally. Preferably, the width of the module carrier 7 is at most 15 mm, the length of the module carrier 7 is then preferably at most 35 mm.

At least one light-emitting diode array 14 is applied on the module carrier 7. The light-emitting diode array 14 comprises at least two light-emitting diode chips 1. The light-emitting diode chips 1 can be applied for example on a ceramic carrier having plated-through holes (vias) for connecting the light-emitting diode chips 1 to the module carrier 7. The ceramic carrier contains for example a ceramic material having good thermal conductivity, such as AlN, and acts as a heat conducting element by which heat generated by the light-emitting diode chips 1 during operation can be dissipated particularly effectively to the module carrier 7. The light-emitting diode chips 1 are preferably light-emitting diode chips of thin-film design. That is to say that the growth substrate of the active, radiation-generating layers of the light-emitting diode chip can be thinned or removed. The active layers can be applied to a carrier element for example by their surface remote from the original growth substrate. Light-emitting diode chips of thin-film design are described for example in the documents WO 02/13281 A1 and EP 0 905 797 A2, the disclosure content of which with regard to the thin-film design of light-emitting diode chips is hereby expressly incorporated by reference.

The light-emitting diode chips 1 are connected, by means of conductor tracks 8 of the module, to a control unit 3, which is suitable for controlling an operating current through the light-emitting diode chips 1. The operating current can be controlled as described above by means of changing the current intensity through the light-emitting diode chips 1 or by means of pulse width modulation.

In a manner integrated into the control unit 3 or arranged as an independent component on the module carrier 7, a memory unit 2 is furthermore applied on the module carrier 7. Initial values of the brightness and the color locus of each light-emitting diode chip 1 are saved in the memory unit 2. The initial values are determined prior to the start-up of the light-emitting diode module 20 at a reference current intensity by means of an external measuring apparatus. The operating current through the light-emitting diode chips 1 is controlled by the control unit 3 in such a way that a particularly exact, reproducible white point representation is effected. In this way, it is also possible for two structurally identical light-emitting diode modules to have an identical white point representation apart from the measurement tolerance during measurement of the initial values.

The control unit 3 and the memory unit 2 can be combined for example in a macrocontroller. The power supply of the control unit 3 from outside the light-emitting diode module 20 is preferably effected via the connector 9.

The control unit 3 can furthermore be suitable for regulating the brightness of the light-emitting diode chips 1 by means of the operating current in a manner dependent on one measured value or a plurality of measured value. In this case, the measured values are dependent on the operating state of the light-emitting diode chips 1. For this purpose, at least one temperature sensor 4 suitable for determining the temperature of one or more light-emitting diode chips 1 can be arranged on the carrier outside or within the light-emitting diode array 14. In this case, it is also possible, in particular, for each light-emitting diode chip 1 to be assigned precisely one temperature sensor 4, such that each temperature sensor essentially determines the temperature of the associated light-emitting diode chip.

The temperature sensor 4 is preferably a thermoelement. Furthermore, the temperature sensor 4 can also be a thermistor, which can have a negative temperature coefficient (NTC thermistor) or a positive temperature coefficient (PTC thermistor). As an alternative, it is also possible to use a semiconductor component, for example a transistor or a diode, as temperature sensor, in which a temperature-dependent electrical property of such a semiconductor component is detected and evaluated by the control unit 3. The temperature sensor 4 is connected to the control unit 3 by means of conductor tracks 8 present on the module carrier 7. The control unit 3 is suitable for evaluating the measured values communicated by the temperature sensor 4 and for correspondingly regulating an operating current through each light-emitting diode chip 1.

The temperature-dependent regulation of the operating current of the light-emitting diode chip 1 of the light-emitting diode module 20 makes it possible to avoid impairment of the function or even failure of the light-emitting diode chips 1 as a result of thermal overloading, for example by the operating current through the light-emitting diode chips 1 being reduced when an critical temperature value is reached and/or exceeded.

Furthermore, a brightness sensor 5 can be applied on the module carrier 7. By way of example, precisely one brightness sensor 5 is assigned one-to-one to each LED array 14. The light-emitting diode chips 1 of the light-emitting diode arrays 14 can then preferably be light-emitting diode chips which emit electromagnetic radiation for the same color.

The brightness sensor 5 is a photodiode, for example. Provision is advantageously made for the operating current of the light-emitting diode chips 1 to be regulated by the control unit 3 in a manner dependent on a luminous intensity measured by the brightness sensor 5. For this purpose, the brightness sensor 5 is preferably connected to the control unit 3, for example by means of conductor tracks 8 of the module carrier 7.

Preferably, the brightness sensor 5 is arranged in such a way that it receives at least part of the radiation emitted by the light-emitting diode chips 1, for example stray radiation. In this case, the signal of the brightness sensor 5 can be evaluated by the control unit 3 in such a way that, by means of a desired/actual value comparison, the brightness of the electromagnetic radiation emitted by the light-emitting diode chips 1 is regulated to a predetermined value, for example the initial value saved in the memory unit 2.

It can be seen from the sectional illustration in FIG. 1B that an optical member 11 can be disposed downstream of the light-emitting diode chips 1 of the light-emitting diode module 20. The optical member 11 is fixed on the module carrier 7 by means of a holder 13, for example. A lens 12 can be an integral component part of the optical member 11 or is applied on the latter.

The optical member 11 is for example a non-imaging optical concentrator that tapers toward the light-emitting diode chips 1.

The optical concentrator can be formed as a hollow body whose inner surfaces are coated in reflective fashion, for example, in metallic fashion.

Furthermore, it is possible for the optical member to be formed as a solid body consisting of a transparent plastic or glass. In this case, the lens 12 can be an integral component part of the optical member 11. Electromagnetic radiation is then guided in the optical member preferably on account of total reflection at the lateral surfaces of the optical member 11.

The lateral surfaces of the optical member 11 are preferably shaped at least in places in the manner of one of the following optical basic elements: truncated-pyramid optical unit, truncated-cone optical unit, compound parabolic concentrator, compound elliptical concentrator, compound hyperbolic concentrator.

FIG. 2 shows an optical projection apparatus comprising a light-emitting diode module 20 as described for example in conjunction with FIGS. 1A and 1B. The optical projection apparatus has an array of micromirrors (digital mirror device—DMD) as imaging element 30. Radiation 21 emitted by the light-emitting diode module 20 impinges on the micromirrors. By the positioning of the micromirrors, a grey-scale image 31 is generated which can be projected onto a projection screen by means of a projection lens 40.

The invention is not restricted by the description on the basis of the exemplary embodiments. Rather, the invention encompasses any new feature and also any combination of features, which in particular comprises any combination of features in the patent claims, even if this feature or this combination itself is not explicitly specified in the patent claims or exemplary embodiments.

This patent application claims the priority of German patent application 102005058884.0-34, the disclosure content of which is hereby incorporated by reference.

1. A light-emitting diode module comprising
at least two light-emitting diode chips (1),
a memory unit (2), in which values for the brightness and the color locus of the at least two light-emitting diode chips (1) are stored, and
a control unit (3), which is suitable for controlling an operating current through each light-emitting diode chip (1), in a manner dependent on the stored value.

2. The light-emitting diode module as claimed in claim 1,
wherein the control unit (3) is suitable for regulating the brightness of each light-emitting diode chip (1) in a manner dependent on at least one measured value, which is in turn dependent on the operating state of the light-emitting diode chip (1).

3. The light-emitting diode module as claimed in claim 1,
wherein the control unit (3) is suitable for controlling the operating current intensity of a light-emitting diode chip (1).

4. The light-emitting diode module as claimed in claim 1,
wherein the control unit (3) comprises a pulse width modulation circuit.

5. The light-emitting diode module as claimed in claim 2,
comprising a temperature sensor (4) suitable for transferring to the control unit a measured value dependent on the operating temperature of at least one light-emitting diode chip.

6. The light-emitting diode module as claimed in claim 2,
comprising a brightness sensor (5) suitable for transferring to the control unit (3) a measured value dependent on the brightness of at least one light-emitting diode chip (1).

7. The light-emitting diode module as claimed in claim 1,
comprising a common module carrier (7) for all the components of the light-emitting diode module (20).

8. An optical projection apparatus comprising
at least one light-emitting diode module (20) as claimed in claim 1,
an imaging element (30), and
a projection optical unit (40).

9. A method for producing a light-emitting diode module as claimed in claim 1, comprising the following steps:
a. equipping a module carrier (7) with at least two light-emitting diode chips (1),
b. measuring the brightness and the color locus of each light-emitting diode chip (1) at a reference current intensity by means of at least one external measuring device,
c. storing the measured values for brightness and color locus of the light-emitting diode chip (1) in a memory unit (2) fixed on the module carrier (7).

10. The light-emitting diode module as claimed in claim 2,
wherein the control unit (3) is suitable for controlling the operating current intensity of a light-emitting diode chip (1).

11. The light-emitting diode module as claimed in claim 2,
wherein the control unit (3) comprises a pulse width modulation circuit.

12. The light-emitting diode module as claimed in claim 3,
comprising a temperature sensor (4) suitable for transferring to the control unit a measured value dependent on the operating temperature of at least one light-emitting diode chip.

13. The light-emitting diode module as claimed in claim 4,
comprising a temperature sensor (4) suitable for transferring to the control unit a measured value dependent on the operating temperature of at least one light-emitting diode chip.

14. The light-emitting diode module as claimed in claim 3,
comprising a brightness sensor (5) suitable for transferring to the control unit (3) a measured value dependent on the brightness of at least one light-emitting diode chip (1).

15. The light-emitting diode module as claimed in claim 4,
comprising a brightness sensor (5) suitable for transferring to the control unit (3) a measured value dependent on the brightness of at least one light-emitting diode chip (1).

16. The light-emitting diode module as claimed in claim 5,
comprising a brightness sensor (5) suitable for transferring to the control unit (3) a measured value dependent on the brightness of at least one light-emitting diode chip (1).

17. The light-emitting diode module as claimed in claim 2,
comprising a common module carrier (7) for all the components of the light-emitting diode module (20).

18. The light-emitting diode module as claimed in claim 3,
comprising a common module carrier (7) for all the components of the light-emitting diode module (20).

19. An optical projection apparatus comprising
at least one light-emitting diode module (20) as claimed in claim 2,
an imaging element (30), and
a projection optical unit (40).

20. An optical projection apparatus comprising
at least one light-emitting diode module (20) as claimed in claim 3,
an imaging element (30), and
a projection optical unit (40).
